(19) United States
(12) Patent Application Publication
(10) Pub. No.: US 2007/0185724 A1
(43) Pub. Date: Aug. 9, 2007

(54) System and method for managing quota groups in a metered service enterprise

(76) Inventor: Robert Moel, Plano, TX (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/348,044

(22) Filed: Feb. 6, 2006

(51) Int. Cl. G06Q 99/00

(52) U.S. Cl. 705/1

(57) ABSTRACT

A method for optimizing the architecture of a quota regime in a metered service enterprise. A quota regime is defined as a service area having a finite service call capacity to provide maintenance services to a subscriber base of the metered service enterprise. The cost of servicing the subscribers within the quota regime is measured by computing the driving cost and the restocking costs associated with dividing the service area into management areas each having an allocation of the finite service call capacity. The optimal number of management areas is determined by finding the lowest aggregate cost of servicing the subscribers over a range of 1 to “n” service areas.

### BACKGROUND

Embodiments of the present invention are directed generally to cable network maintenance and more specifically to a system and method for establishing and supplying maintenance centers.

Cable networks deliver voice, data, and video to subscribers over a complex network of headends, regional data centers, hubs, and nodes. At the upstream terminus of the network is the headend and regional data center. Typically, a head end comprises the analog and digital video signal processors, video on demand systems, and other video content management devices. A regional data center comprises digital service management devices (e-mail servers, DNS, and Internet connectivity) and routers that interconnect the regional data center with a headend. A hub receives the video and data signals from the headend and regional data center, processes these signals through appropriate modulators, and sends these signals downstream to a hub. The hub provides the signals to a node that is ultimately associated with individual subscribers. A node provides an interface between the fiber-based component of the HFC cable network and the RF/cable component of the network that is the transport media to the home.

In a commercial network, a headend may service multiple hubs and a hub may service multiple nodes. A regional data center may provide digital services to multiple headends. From a node to the home, the RF/cable component of the HFC cable network may branch numerous times. Amplifiers, line extenders, and passive devices are employed to maintain signal quality across all branches (or “cascades”) serviced by the node.

FIG. 1 illustrates typical prior art cable system architecture. A headend 100 comprises a network control system 102 that handles set-top provisioning, system management and interactive session set-up, a video signal processor 104 that handles content acquisition and delivery, 256 QAM Modulators 111 that generate modulated RF streams of digital video signals, a high speed data interface 106, and a billing system 107.

Headend 100 communicates with hub 108. Hub 108 comprises a cable modem termination system 110, a 256 QAM modulator 112 for downstream data traffic, a QPSK modulator for downstream Out-of-Band Data traffic 114, and a QPSK demodulator 116 for upstream Out-of-Band Data traffic. As will be appreciated by those skilled in the art, a hub may comprise multiple instances of each device illustrated in FIG. 1.

Hub 108 communicates with nodes 120A, 120B and 120C. Nodes 120 provide an interface between the fiber-based transport medium of the cable network (between the headend 100 and upstream side of nodes 110) and the coax-based medium (between the downstream side of nodes 110 and the subscriber interface 145). The downstream side of node 110B is further illustrated as connecting to bridger amplifier 1 125 which in turn is connected to bridger amplifier 2 130. The serial path from node 120B through bridger amplifier 1 125 to bridger amplifier 2 130 is referred to as a cascade relative to node 120B. Bridger amplifier 1 125 has three branches that are cascades relative to bridger amplifier 1 125 and sub-cascades relative to node 120B.

As will be appreciated by those skilled in the art, FIG. 1 is a greatly simplified schematic of cable network architecture. A hub typically serves 20,000 subscribers. A typical hub supports from 50 to 100 nodes with each node capable of serving 250 to 2000 subscribers. In order to maintain signal quality and quality of service commitments, trunk amplifiers maintain high signal quality. Internal bridger modules in the trunk amplifiers boost signals for delivery to subscribers' homes. Line Extender amplifiers maintain the high signal levels in cascade after the trunk amplifiers, through the neighborhoods. Taps divide out small amounts of signal for connection to the homes. Nominal cascade limits are up to 4 trunk amplifiers followed by up to 3 line extenders, with more in very rural areas. In suburban areas, cascades typically comprise 2 trunk and 2 line extenders. Because branching is unlimited, the total device count per node may be large despite short cascades.

At the downstream end of the network is the customer premises equipment (CPE). Referring again to FIG. 1, subscriber interface 145 connects a set top box (STB) 150 and a cable modem (CM) 155 to the HFC cable network. The CPE receives content from a headend or regional data center and provides access to it by a subscriber. For example, video programming is delivered to STB 150 and high speed data services are delivered to CM 155.

The complexity of cable networks makes network fault isolation and maintenance a challenging task. The task can be partitioned into four stages:

determining that a failure has occurred or is imminent;

determining what has failed;

determining where in the network the failure is likely to be; and

determining what equipment is required to remedy, or prevent, the failure.

Structural and procedural concepts for isolating and correcting faults in network components and CPE have been disclosed in U.S. patent application Ser. No. 11/040,391, filed Jan. 21, 2005, for “A Fault Isolation System And Method;” in U.S. patent application Ser. No. 11/069,155, filed Mar. 1, 2005, for “An Early Warning Fault Identification And Isolation System For A Two-Way Cable Network;” in U.S. patent application Ser. No. 11/069,156, filed Mar. 1, 2005, for “A Fault Detection And Isolation System For An HFC Cable Network And Method Therefor;” and U.S. patent application Ser. No. 11/069,080 filed Mar. 1, 2005 for “A System And Method For Identifying And Isolating Faults In A Video On Demand Provisioning System.” The Ser. No. 11/040,391, the Ser. No. 11/069,155, the Ser. No. 11/069,156 and the Ser. No. 11/069,080 applications are incorporated herein in their entirety for all purposes.

Having determined that a problem in an HFC cable network has occurred or is imminent, establishing efficient and cost effective systems for assuring the correction of the fault is a challenging task. Properly staffing and routing of field staff is essential to delivering high-quality in field service. Two decisions that determine the effectiveness of the field service are the size of the service area covered by a field service unit (determines the driving costs), and the size of the inventory of spare components that are shared by some number of field service units (determines the stocking and restocking costs).

What would be useful would be system and method for establishing a field maintenance system that would optimize the size of maintenance areas and spare component inventories shared among maintenance areas.

### SUMMARY

An embodiment of the present invention provides a method for designing a cost efficient maintenance supply architecture for an HFC cable network. According to this method, a finite service call capacity (expressed as “truckrolls” or a “service call capacity”) is shared among a variable number of service facilities or “quota groups” within a finite geographic area of interest. The finite service call capacity is determined by the number of trucks, the inventory of parts, and the availability of service personnel. A restocking cost and an average driving cost are associated with the incremental change in the number quota groups. The method optimizes the combined restocking and driving costs to arrive at a maintenance supply architecture for the area of interest in which the most cost effective number of quota groups is determined.

As will be appreciated by those skilled in the art, the maintenance supply architecture described herein is not limited to HFC cable networks. Other enterprises that depend on continuous customer support to maintain a revenue stream (that is, suppliers of “metered services”) are candidates for using the present invention. By way of illustration and not as a limitation, power companies, fuel supply companies, and water supply companies would benefit from utilizing the present invention.

It is therefore an aspect of the present invention to determine an average driving cost for a defined geographic area of interest.

It is another aspect of the present invention to determine a probability of having resources to respond to a request for service for a geographic area of interest having “n” service facilities sharing a service call capacity of “m” truckrolls.

It is yet another aspect of the present invention to determine the cost of replenishing the inventory of the “n” service facilities sharing a service call capacity of “m” truckrolls.

It is still another aspect of the present invention to determine an optimum number nₒₚₜ of service facilities for a geographic area based on the combine average driving cost and replenishment cost.

It is an aspect of the present invention to increase the efficiency of maintenance field personnel and to improve responsiveness to customer service needs.

An embodiment of the present invention provides a method for managing quota groups in a metered service enterprise. A quota regime comprising 1 to “n” management areas is defined. Each of the 1 to “n” management areas comprises a quota group. A quota regime cost to provide service to a subscriber base within the quota regime over the range 1 to “n” is determined. An integer value of “n” (herein, nₒₚₜ) within the range of 1 to “n” associated with the lowest quota regime cost is determined. The quota regime with nₒₚₜ management areas is established.

In another embodiment of the present invention, the method further provides for establishing the quota regime driving cost and a quota regime restocking cost as part of the quota regime cost.

In yet another embodiment of the present invention, establishing the regime driving cost comprises establishing an aggregate of a zone driving cost associated with each of the 1-n management areas. In this embodiment, the zone driving cost equals D(p,q)*Cfleet*P*ρ/30.25, wherein D(p,q) is a measure of an average trip in miles for an area of “p”×“q” square miles, P is a size of the subscriber base, Cfleet is a driving cost in monetary units per mile, ρ is a monthly service call rate for the area, and 30.25 is an average days in a calendar month. In still another embodiment, D(p, q)=p/3+q/3.

In an embodiment of the present invention, establishing regime restocking cost comprises establishing the aggregate of a zone restocking cost associated with each of the 1-n management areas. In this embodiment, the zone restocking cost equals 24/E_{Ξ,1}(x)C_{stockout,} wherein E_{Ξ,1}(x) is the expected life in hours of the quota group within each of the 1-n management areas, 24 is the number of hours in a day, C_{stockout} is a cost per stock-out.

In another embodiment of the present invention, the subscriber base comprises a population of subscribers using a metered service. By way of example and not as a limitation, the metered service may be a cable television service, a video on demand service, an electrical power service, a water supply service, and a fuel supply service.

### DESCRIPTION OF THE DRAWINGS

FIG. 1 illustrates typical prior art cable system architecture.

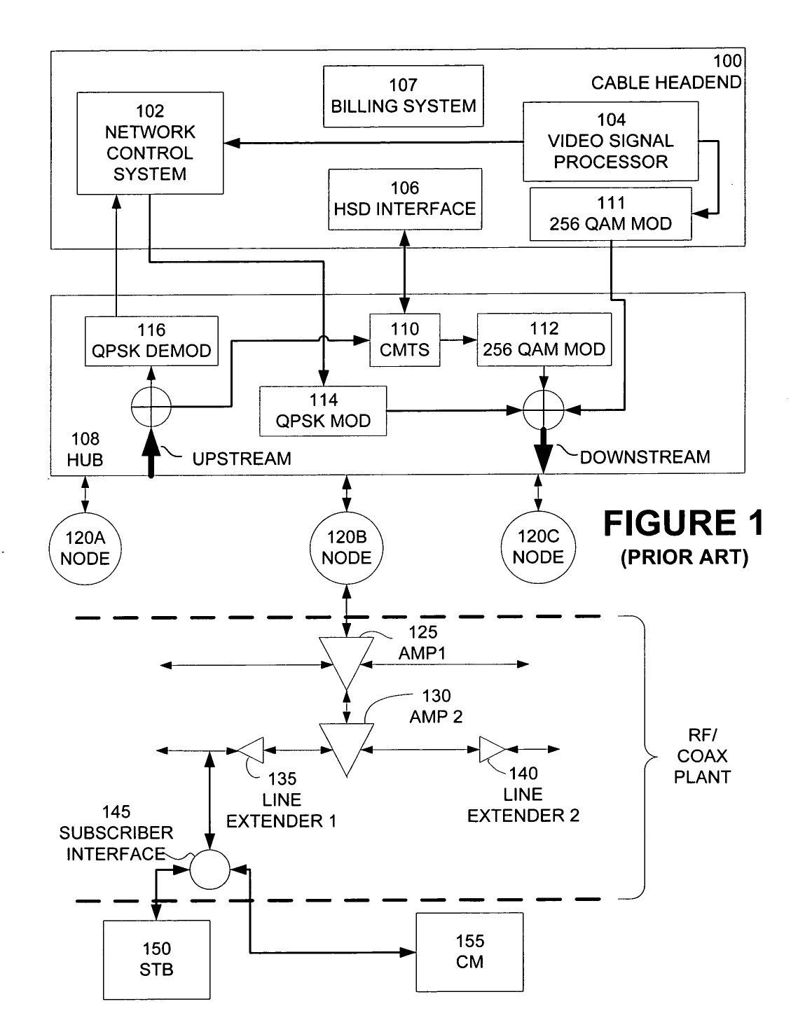

FIG. 2 illustrates a curve reflecting how the life of the quota regime changes as the number of quota groups is increased according to an embodiment of the present invention.

FIG. 3 illustrates an analysis of quota regime costs for a particular set of factors according to an exemplary embodiment of the present invention.

### DETAILED DESCRIPTION

The following terms are used in the description that follows. The definitions are provided for clarity of understanding:
finite service call capacity—A measure of the capacity of a management area to respond to a request for maintenance from a subscriber within the management area. The size of the service call capacity is represented by “m” in the equations presented herein.
HFC—Hybrid-Fiber-Coax. A network design that employs both fiber optic and coaxial cables to deliver cable video and data services.
management area—The area supported by a finite service call capacity finite of “truckrolls.” The management area is expressed as an area of “p” by “q” in the equations presented herein.
quota group—A service facility supported by the management area. The number of quota groups within a management area is expressed as the variable “n” in the equations presented herein. The “n” quota groups share the finite service call capacity.
quota regime—A collection of management areas and quota groups that share the finite service call capacity.
request rate—The rate requests for service are received by a management area expressed in truckrolls per hour. The rate is represented by the variable “θ” in the equations presented herein and is dependent on the number of subscribers located within the management area.
stockout—the number of times in a 24 hour day the quota group will service call capacity necessary to service the management area
stockout cost—The cost to replenish the service call capacity following a stockout.

An embodiment of the present invention provides a method for designing a cost efficient maintenance supply architecture for an HFC cable network. According to this method, a finite service call capacity (expressed as “truckrolls” or a “finite service call capacity” and represented by the variable “m”) is shared among a variable number “n” of service facilities or “quota groups” within a finite geographic area of interest referred to herein as a “management area.”

The finite service call capacity is determined by the number of trucks, the inventory of parts, and the availability of service personnel. A restocking cost and an average driving cost are associated with the incremental change in the number quota groups within the management area. The method optimizes the combined restocking and driving costs to determine a maintenance supply architecture for the area of interest in which the most cost effective number of quota groups is determined.

For example, for a management area of a given size and aspect ratio, the expected driving distances for service calls that are uniformly but randomly distributed in a rectangle of dimensions p and q is:

$${\int }_{0}^{q} {\int }_{0}^{q} {\int }_{0}^{p} {\int }_{0}^{p} \frac{\sqrt{{( {x}_{1} - {x}_{2} )}^{2} + {( {y}_{1} - {y}_{2} )}^{2}}}{{p}^{2} {q}^{2}} ⅆ {x}_{1} ⅆ {x}_{2} ⅆ {y}_{1} ⅆ {y}_{2} \qquad ( Equation 1 )$$

The points (x₁, y₁) and (x₂, y₂) make up the random points. The distances of these line segments are then averaged. Another, perhaps slightly more realistic travel distance formulation would assume only right angled travel was permitted, thus providing. Cities are laid out in grids and, typically, diagonal travel is not possible. The equation for that expected value would be:

$$D ( p , q ) = {\int }_{0}^{q} {\int }_{0}^{q} {\int }_{0}^{p} {\int }_{0}^{p} \frac{\vert ( {x}_{1} - {x}_{2} ) \vert + \vert ( {y}_{1} - {y}_{2} ) \vert}{{p}^{2} {q}^{2}} ⅆ {x}_{1} ⅆ {x}_{2} ⅆ {y}_{1} ⅆ {y}_{2} \qquad ( Equation 2 )$$

Where “D” is the average driving distance between points with area “p×q.”

Solution of equation #1 would generally require computer assistance. However, Equation 2, has a simple closed form solution indicated below:
D(p, q)=p/3+q/3 (Equation 3)

Clearly, the larger the land area, the longer the average driving distance will be. Another fact that is evident from Equation 3 is that two management areas may have the same areas but different average driving distances. By way of illustration, an equilateral management area having p=q=2 has 1.33 as its average distance while a management area having p=4 and q=1 will have an average driving distance of 1.67 or nearly 25% longer average travel distances.

A cost of travel may be derived from the average trip distance computed for a particular management area. The driving cost is:
DrivingCost=D(p,q)*Cfleet*P*ρ/30.25 (Equation 4), where
D(p,q) is the average trip in miles for an area of “p”×“q” square miles, P is the number of subscribers with the area, Cfleet is the driving cost in monetary units per mile, ρ is the monthly service call rate for the area, and 30.25 is the average days in a calendar month.

Thus, for an area 1 miles by 4 miles, serving 1000 customers, with a monthly service call rate of 302.5 and a driving cost of $1.00 per mile, the daily driving cost is $16,700 (e.g., [1/3+4/3]*$1.00*302.5/30.25*1000). Whereas, if the area is 2 miles by 2 miles, the driving cost is $13,333 (e.g., [2/3+2/3]*$1.00*302.5/30.25*1000).

If average driving distance were the only factor, management areas would be made as small as possible because driving distances would be minimized. However, dividing a management area into smaller zones while keeping the finite service call capacity constant increases the probability that one of the smaller zones will exhaust its allotment of inventory sooner.

By way of illustration, a management area of “n” quota groups is served by a finite service call capacity of “m.” Each request for service arrives following the well known exponential distribution at θ requests per unit time. If no new inventory is added to the finite service call capacity until the inventory reaches zero, the average time for the finite service call capacity to be exhausted is determinable by application of the Erlang distribution (the integer version of the Gamma distribution). The probability density function for this distribution is:

$${f}_{X} ( x ) = \frac{{θ}^{m} {x}^{m - 1} {ⅇ}^{- θ x}}{Γ ( m )} , x \geq 0 \qquad ( Equation 4 )$$

Equation 4 provides a probability that a management area served by a finite service call capacity of a size “m” will be exhausted within a time “x.”

The expected life of a single quota group within the management area is:
m/θ Equation #5, where
m is the inventory size and θ the request rate for inventory within the quota group.

Equation 5 represents the time a single quota group with access to a service call capacity of “m” truckrolls in an environment where requests for service arrive at a rate of “θ” requests for truckrolls per hour will last on average until the quota group is exhausted.

A quota regime is the arrangement of quota groups and management areas. For example, a finite service call capacity “m” may be spread across one or several management areas. Assuming that a quota regime is functioning if each quota group has available units to serve to its management area and fails if any one quota group fails, and that an individual a service call quota life follows a gamma distribution, the expected life and variance of a given quota regime can be determined. Stated another way, the average life of “n” quota groups subject to uniform requests whose rate is dependant upon the number of customers in a management area can be determined using probability analysis.

$$Ξ ( x ) := 1 - {[ 1 - {\int }_{0}^{x} {( \frac{θ}{n} )}^{\frac{m}{n}} \cdot {x}^{( \frac{m}{n} ) - 1} \cdot \frac{exp ( x \cdot \frac{- θ}{n} )}{Γ ( \frac{m}{n} )} ⅆ x ]}^{n} \qquad Equation \#6$$

This cumulative distribution function, Big-Chi, computes the probability of n-chained quota groups living to x time. The expected value of Big-Chi is:

$$E ( x ) := {\int }_{0}^{∞} x \cdot [ \frac{ⅆ}{ⅆ x} ( Ξ ( x ) ) ] ⅆ x \qquad Equation \#7$$

and the second moment of Big-Chi is:

$$E ( {x}^{2} ) := {\int }_{0}^{∞} {x}^{2} \cdot [ \frac{ⅆ}{ⅆ x} Ξ ( x ) ] ⅆ x \qquad Equation \#8$$

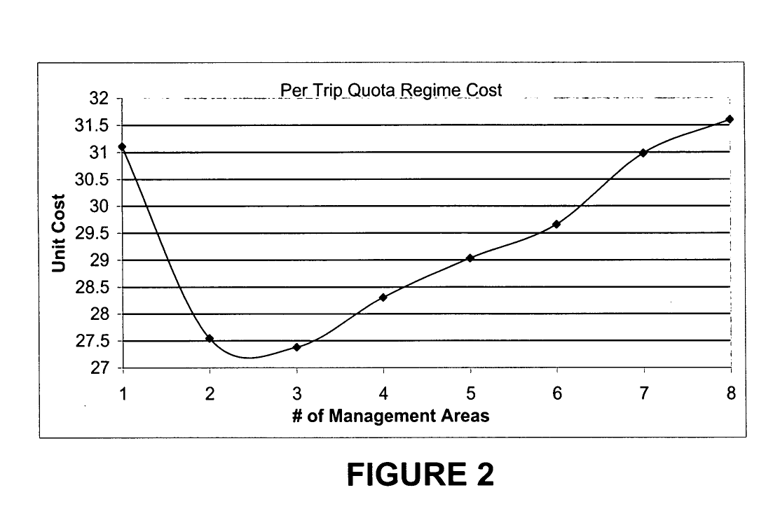

FIG. 2 illustrates a curve reflecting how the life of the quota regime changes as the number of quota groups is increased according to an embodiment of the present invention. Referring to FIG. 2, the request rate (θ) for the quota regime is assumed to be θ=4 requests/hour and size of the service call quota assumed to be 200. As the number of quota groups is increased from 1 to 20, the life of the quota regime, on average, is cut by 50%. Said another way, the probability that a quota regime with 10 quota groups with 200 units spread across them and a request rate of 0.4 per hour (θ/n=4/10=0.4) fails after 25 hours is 3.4% but, the probability that a quota regime with 20 quota groups and a request rate of 0.2 per hour (θ/n=4/20=0.2) and the other elements the same fails is 47.6%.

If E_{Ξ,1}(x) is the expected life in hours of a quota regime with 1 quota group, then the number of times in a 24 hour day the quota group will exhaust the finite service call capacity necessary to service the management area (herein, a “stockout”) is 24/E_{Ξ,1}(x). If the cost per stock-out is C_{stockout} then the total daily restocking cost (or stockout cost) is 24/E_{Ξ,1}(x)C_{stockout}.

In an embodiment of the present invention, the total regime costs equal the “stockout cost” plus the driving cost. The optimum architecture of a quota regime in terms of the most cost effective number of quota groups can be determined by analyzing the regime costs as a function of the number of number of quota groups.

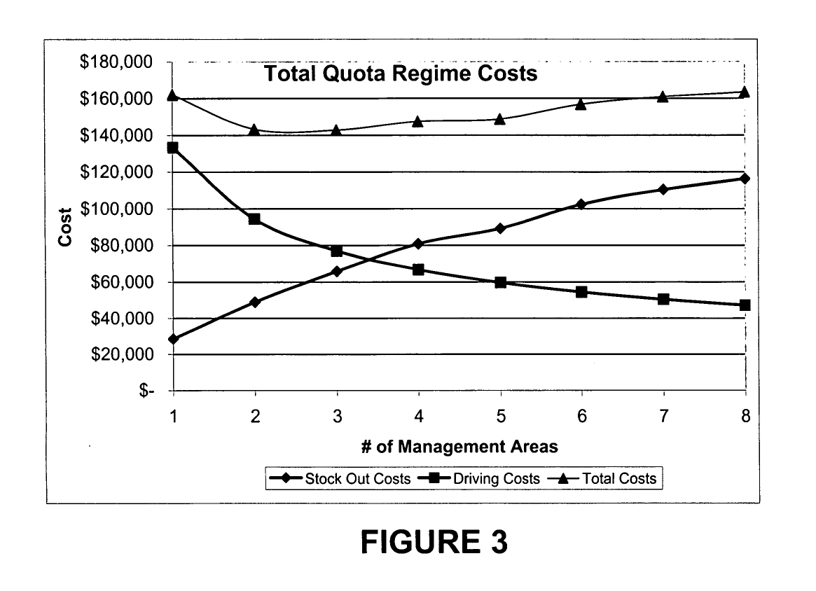

FIG. 3 illustrates an analysis of quota regime costs for a particular set of factors according to an exemplary embodiment of the present invention. In this exemplary embodiment of the present invention, the quota regime analysis was derived using the factors set forth in Table 1 below:

TABLE 1

| | |
|---|---|
| Cost Per Mile | $0.70 |
| Stock Out Cost | $300.00 |
| Stranding Costs | $5.00 |
| Total Width of Management Area (‘p”) | 75.00 |
| Total Height of Management Area (“q”) | 35.00 |
| Total Quota (Finite service call capacity) (“m”) | 840 |
| Number of Trips | 5200 |
| Ave. Req. Rate (“θ”) | 15 |

Table 2 illustrates the Quota Regime Costs where a management area is supported by a dedicated quota group and the number of management areas, and hence, the number of quota groups (“n”), within the quota regime is varied from 1 to 8. In this exemplary embodiment of the present invention, the total quota (or service call capacity) is spread evenly over the number of management areas.

TABLE 2

| Mgt | Stockout | Driving | Total Quota | Per |
|---|---|---|---|---|
| Areas | Costs | Costs | Regime Costs | Trip |
| 1 | $27,750.00 | $133,466.67 | $161,216.67 | $31.00 |
| 2 | $49,360.00 | $94,375.19 | $143,735.19 | $27.64 |
| 3 | $64,415.00 | $77,057.02 | $141,472.02 | $27.21 |
| 4 | $80,095.00 | $66,733.33 | $146,828.33 | $28.24 |
| 5 | $91,892.00 | $59,688.11 | $151,580.11 | $29.15 |
| 6 | $102,480.00 | $54,487.54 | $156,967.54 | $30.19 |
| 7 | $110,645.00 | $50,445.66 | $161,090.66 | $30.98 |
| 8 | $117,015.00 | $47,187.59 | $164,202.59 | $31.58 |

Table 2 reflects the competition between the stockout costs and the driving costs. As the number of management areas increases, the size of the management area decreases thereby lowering the averaging driving distance and driving costs. On the other hand, the stockout costs increase with the increased probability that a quota group will “stock out” as the number of quota group increases. In this exemplary embodiment of the present invention, the optimum per trip costs and the optimum total regime costs are achieved when the number of management areas (hence, the number of quota groups) is three.

A method for designing a cost efficient maintenance supply architecture for an HFC cable network has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

What is claimed is:

1. A method for managing quota groups in a metered service enterprise:
defining a quota regime comprising 1 to “n” management areas, wherein each of the 1 to “n” management areas comprises a quota group;
determining a quota regime cost to provide service to a subscriber base within the quota regime over the range 1 to “n”;
determining an integer value of “n” (herein, nₒₚₜ) within the range of 1 to “n” associated with the lowest quota regime cost; and
establishing the quota regime with nₒₚₜ management areas.

2. The method for managing quota groups of claim 1 further comprising:
establishing the quota regime driving cost and a quota regime restocking cost as part of the quota regime cost.

3. The method for managing quota groups of claim 2, wherein establishing the regime driving cost comprises establishing an aggregate of a zone driving cost associated with each of the 1-n management areas.

4. The method for managing quota groups of claim 3, wherein the zone driving cost equals D(p,q)*Cfleet*P*ρ/30.25, and wherein D(p,q) is a measure of an average trip in miles for an area of “p”×“q” square miles, P is a size of the subscriber base, Cfleet is a driving cost in monetary units per mile, ρ is a monthly service call rate for the area, and 30.25 is an average days in a calendar month.

5. The method for managing quota groups of claim 4, wherein D(p, q)=p/3+q/3.

6. The method for managing quota groups of claim 2, wherein the establishing regime restocking cost comprises establishing the aggregate of a zone restocking cost associated with each of the 1-n management areas.

7. The method for managing quota groups of claim 6, wherein the zone restocking cost equals 24/E_{Ξ,1}(x)C_{stockout}, wherein E_{Ξ,1}(x) is the expected life in hours of the quota group within each of the 1-n management areas, 24 is the number of hours in a day, C_{stockout} is a cost per stock-out.

8. The method for managing quota groups of claim 1, wherein the subscriber base comprises a population of subscribers using a metered service.

9. The method for managing quota groups of claim 8, wherein the metered service is selected from the group consisting of a cable television service, a video on demand service, an electrical power service, a water supply service, and a fuel supply service.
